(19) United States
(12) Patent Application Publication
(10) Pub. No.: US 2005/0288951 A1
(43) Pub. Date: Dec. 29, 2005

(54) Interactive multiple-video webcam communication

(76) Inventors: Guy Stone, La Jolla, CA (US); Alexey Suhih, San Diego, CA (US)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/129,243

(22) Filed: May 13, 2005

Related U.S. Application Data
(63) Continuation-in-part of application No. 09/614,238, filed on Jul. 12, 2000.

(51) Int. Cl. G06Q 99/00

(52) U.S. Cl. 705/1

(57) ABSTRACT

This invention allows users to chat online while displaying live webcam images of multiple selected users within an Internet chatroom environment. This technology is unique to the field because: 1) Java Programming Language is used, enabling the program to work across all platforms; 2) the number of users that are allowed to participate in the chatroom is not limited; 3) well-defined Internet standards are used to transfer and display files; 4) webcam images are automatically uniformly sized; 5) users can select the webcam images they want to view from a list of chatters. This invention also discloses a method of providing customer service and the corresponding system utilizing the above-mentioned technology, enabling a customer and representative to interact visually, orally, and/or textually via live webcam images, Voice over Internet Protocol, Instant Messaging System, and/or e-mail.

This application claims benefit of U.S. Ser. No. 09/614,238, filed Jul. 12, 2000, the contents of which are incorporated herein in its entirety by reference.

Throughout this application, various publications are referenced. Disclosures of these publications in their entireties are hereby incorporated by reference into this application to more fully describe the state of the art to which this invention pertains.

### BACKGROUND OF THE INVENTION

People, by their gregarious nature, enjoy seeking social interaction with other individuals with similar interests. Chatrooms are virtual lounges where a number of Internet users can meet to speak, or chat, about any subject of interest to them. The first Internet chatrooms appeared in April 1995 (1) and the concept has quickly become a staple in the Internet world. Chatrooms attract a variety of users from throughout the world for the purposes of live “talk,” which is typically represented in text form as users type in and send their comments (2).

Some Internet chatrooms also feature a single live photo image that users (also known as “chatters”) can view once they enter the chatroom. These images are transmitted via a webcamera (or “webcam”) attached to the computer of the chatter who wants his/her image transmitted. Chatters can view the live image of one other chatter using webcam technology (3). A chatter who wishes to offer his/her image via webcam can set his/her camera to take a snapshot of him/her at his/her computers at preset intervals (i.e. every 30 seconds, 1 minute, etc.). In this way, the other chatters can see this person's image change at the same rate. The webcam can be positioned to take pictures of anything within the webcam's range (i.e. the chatter's companions in the same room, other sections of the room).

In 1984, a company called White Pine developed CU-SeeMe, a video chat software. The company has since changed its name to CU-SeeMe Networks, and it hosts an Internet site (http://www.cuseemeworld.com/) which allows chatters to view live video and hear audio of other chatters (4). The site consists of several chatrooms organized by chatters' areas of interest (i.e. a relationship chat area, a women's chat area, a travel chat area, etc.). Each of these areas contains at least one chatroom.

For instance, the travel chat area contains chatrooms for San Francisco, New York, Paris, etc. When a user enters a chatroom, he/she sees three squares at the top of the page. These squares are designed to display live video photos of the chatters. There are two rectangular regions below the video area. The one to the left is for chat text, and the one to the right contains a list of chatters. As is the case with many other Internet chatrooms, there is a blank space at the bottom of the page where chatters can type in their messages, and several buttons: “Send Chat” (to send chatter's typed message into the chat area), “Show Video” (to show video of a particular chatter), “Show Profile” (to display a profile of a certain chatter), and “Hang Up” (to leave the chatroom).

The company's background is in videoconferencing, and their software reflects this. For instance, among the disadvantages: 1) the CU-SeeMe software program works only on the Microsoft Windows Platform; 2) the program only allows a maximum of 25 people in a single chatroom and displays a maximum of three webcam photos at the top of the page; and 3) CU-SeeMe World uses its own proprietary transfer protocol to transfer files to each user.

In another realm of social interaction, businesses frequently have to interact with their customers to answer questions, resolve problems, and/or otherwise further their business relationship. Because of issues such as geographical distances and scheduling, such interactions often take place via telephone, letters, facsimile, e-mail, and the like. While these means for communication may serve their bare minimal purpose, they still fall short of the effectiveness of face-to-face interaction, which is more personal and permits both parties to observe the body language of the other. Providing effective customer service is a necessary aspect of retaining and attracting customers, which in turn, translates to financial growth and prosperity for a business. The present invention satisfies this need by disclosing a method of customer service that provides the virtual equivalent of “a smiling face behind the counter” along with an effective means for communication.

### SUMMARY OF THE INVENTION

This invention provides a software program that allows users to chat with each other while displaying live webcam images of more than one selected user within an Internet chatroom environment. The webcam images are displayed at the top of the chatroom page, and chat text runs below the images. Different webcams may transmit their images in different size, but this invention automatically makes all the images appear in uniform size. The invention also automatically assigns each image a position on the chatroom screen. If the number of chatters falls below the number of available image positions (or some chatters do not have a webcam or do not want their images projected) the program automatically displays a preselected logo (i.e. the logo of the company running the chatroom).

Another outstanding feature of this program is that chatters can select the webcam images they want to view while they are chatting. Each webcam has a URL (Uniform Resource Locator) which the webcam owner programs into the webcam after purchasing it. This program asks each chatter for his/her URL and then organizes all the URLs of incoming chatters so that their webcam images are readily available to other chatters. The program provides a running list of the screen names of all participants in the chatroom. When a chatter enters, his/her screen name appears on the list. When the chatter exits, his/her screen name disappears, too.

If, for instance, Chatter 1 prefers to view a webcam image of Chatter 13 or Chatter 4, he/she can do so immediately by double-clicking his/her mouse on Chatter 13's screen name. Chatter 13's image will suddenly appear at the top of the screen alongside the images of the other chatters that Chatter 1 has chosen to view. The invention identifies each image by screen name. Chatters who do not have a webcam are identified by a common symbolic logo (i.e. the logo of the company or organization running the chatroom) in place of their image. The program updates the symbolic logo at a predefined interval.

In another embodiment, the invention provides a method of providing customer service, comprising the steps of providing a means for instantly contacting one or more representatives by one or more customers, providing a means for real-time and simultaneous interaction between one or more representatives and one or more customers, and providing a means for displaying live webcam images of one or more representatives and one or more customers during said interaction. The corresponding system for the above-mentioned method is also disclosed. Customers need not download additional software to utilize this method of customer service and can interact with representatives visually, orally, and/or textually. Furthermore, representatives can interact with each other during a session with minimal disruption to the customer.

### BRIEF DESCRIPTION OF THE DRAWINGS

FIG. 1 is a simple diagram showing how the client program works from a user's perspective.

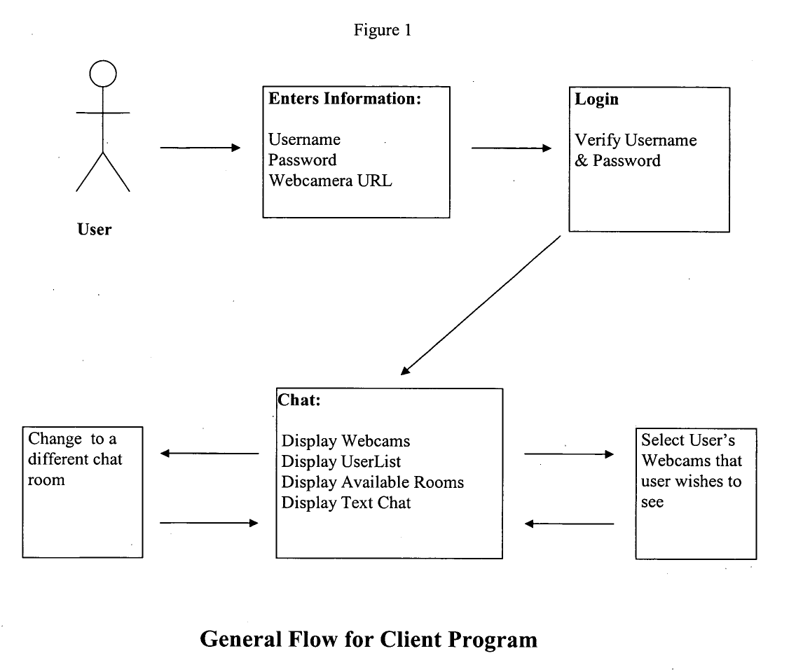

This figure shows a general path that a user would take when using the client program over the Internet.

FIG. 2 is a flow chart for the Chat portion of the client.

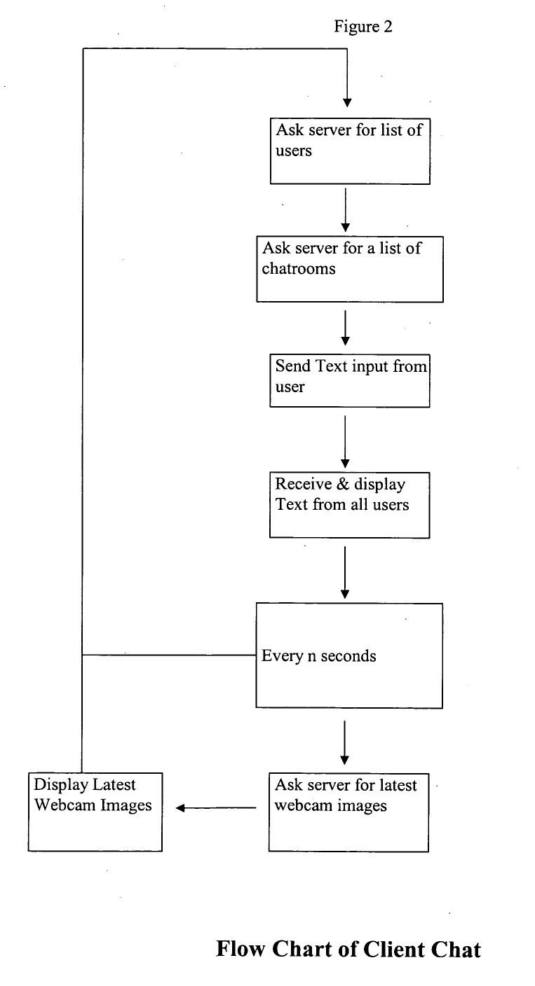

This diagram shows the order that the client sends requests to the server to update each individual piece of the software.

FIG. 3 is a diagram showing the general architecture of the server portion of the present invention.

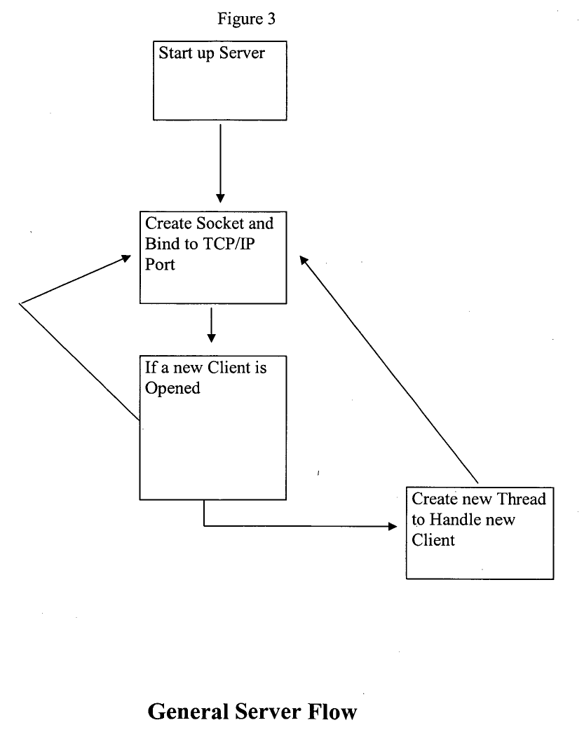

This shows the general flow of the server portion of the program. The server portion relies heavily on multi-threading.

FIG. 4 is a diagram showing a more detailed implementation of the thread that handles each client.

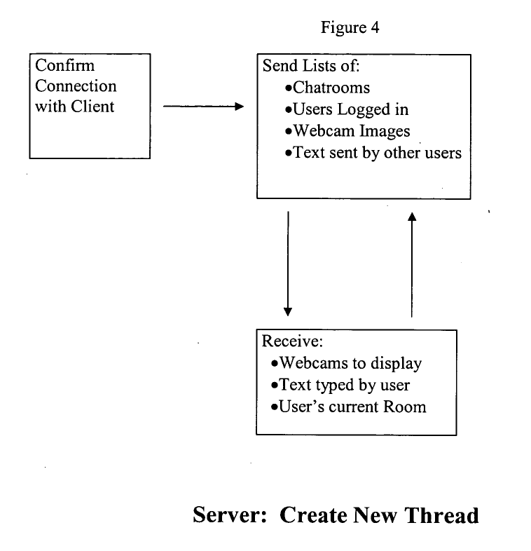

This shows the threads most basic states: sending & receiving. The thread receives a command from the client and then sends back a response.

FIG. 5 is a drawing of a possible interface that appears on each chatter's screen, i.e., the client program.

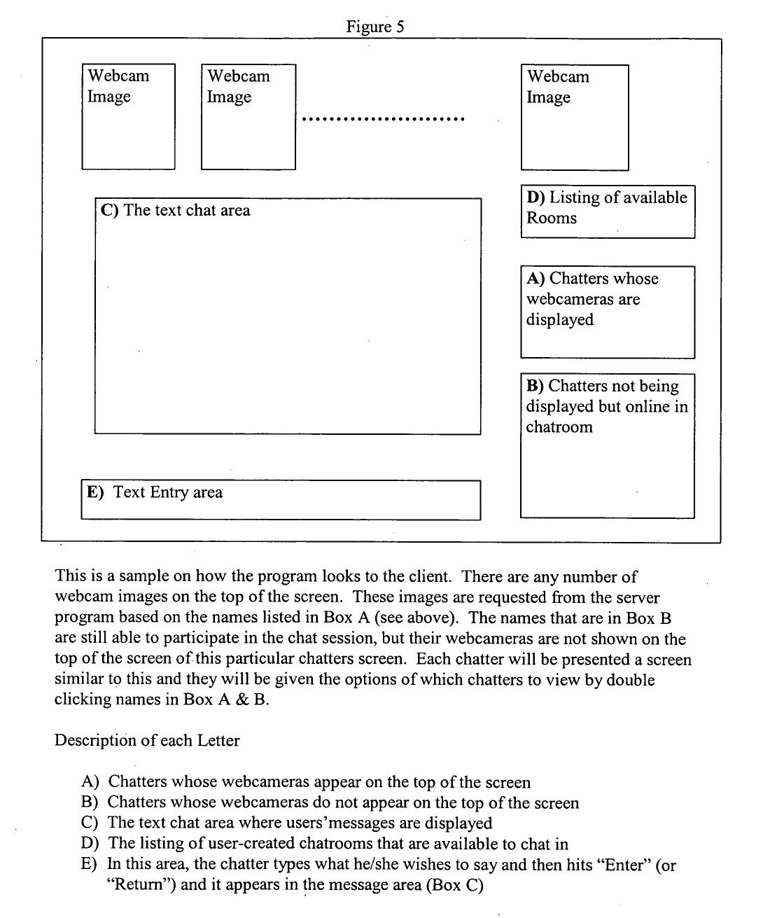

This figure shows how the client program looks, how the elements on the interface work with one another to display the webcam images and text on each user's screen. The interactions that the chatter can take are also documented in this figure.

FIG. 6 is a flow chart for the customer service aspect of the invention.

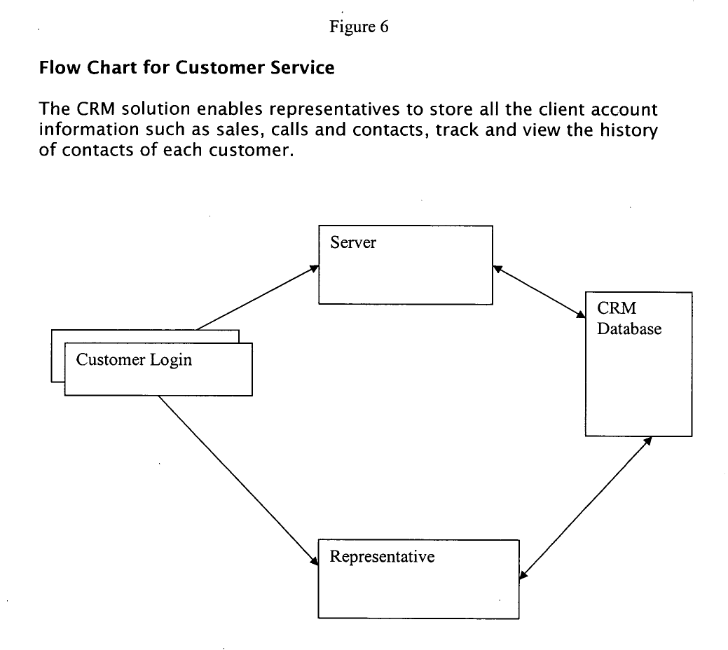

This flow chart illustrates the general relationship of the system of the present invention.

FIG. 7 is a drawing of a possible interface for the customer service aspect of the invention.

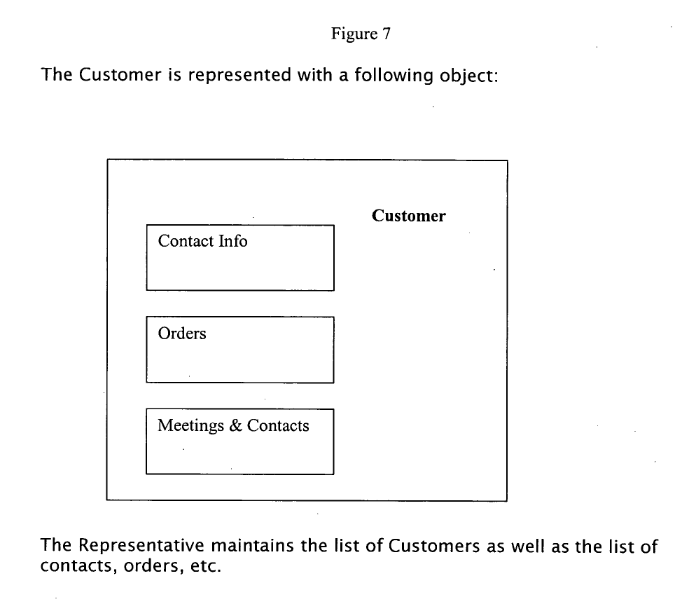

This drawing illustrates one embodiment as to how a customer may be represented to a customer service representative.

### DETAILED DESCRIPTION OF THE INVENTION:

Terminology Definitions:

Chatroom—An Internet-based technology that allows multiple users to virtually meet in one place and type messages to one another that will be visible to all within the room.

Web Camera—Any device attached to a computer that transmits images over the Internet, most commonly the World Wide Web.

WebCam—A generic term for any type of web camera.

Java Virtual Machine (or JVM)—A program that interprets compiled Java Code, which allows it to run on any computer platform.

Applet—A Java program that runs inside of a Java-enabled Web Browser.

SGML—A standardized markup language for defining the logical structure of a computer document.

HTML—A subset of SGML that is used to format documents over the Internet.

Multi-threading—The ability to run several threads at the same time. Each thread acts like a mini program that shares data with the main program.

Protocol—A standard way to send a message across some communication median.

Graphical User Interface (or GUI)—A Window-based system, where the user of the system uses a mouse to point and click.

Discussion Room—A separate room inside the main chatroom that tends to be focused on a separate discussion. A chatter can only be a member of one discussion room at a time, and all of the messages sent into other discussion rooms are not posted.

File Transfer Protocol (or FTP) (5)—A protocol that defines a way to copy files over the Internet.

Transmission Control Protocol (or TCP) (6)—An open standard that defines how to connect and transfer data over the Internet.

Username—Each user in the system is displayed by a name that they choose. All usernames have to be unique.

Client—A program that acts as the front end to each individual user and runs on each user's machine. It receives all the chatroom information from the server via the Internet.

Server—The part of the program that runs on a centralized machine and keeps the client programs synchronized.

Internet—The loose association of millions of computers that allows all users to communicate with one another.

All Words ending “.java”—The name of the source code file that a description deals with.

Chatroom Environment

The invention disclosed in this application provides for multiple webcam images in a chatroom environment, but there are several major differences in this invention and CU-SeeMe's technology discussed in the Background of the Invention section: 1) This invention uses Java Programming Language, and the same program works across all platforms. That means it works in all computers that are capable of running a Java Virtual Machine. Today, most computers are equipped with a Java Virtual Machine, as are most web browsers (including Microsoft's Internet Explorer and Netscape's Navigator). This allows people to use the software without any additional plug-ins. 2) This invention has no limit on the number of users that are allowed to participate in the chatroom, and the computer-user's screen size is the only limit on the number of live webcam photos that can be displayed on the page. Those with small screens can view four live photos, for instance, and those with larger screens can view six or more live photos. In other words, the invention customizes itself to fit each user's computer system. 3) This invention uses well-defined Internet standards to transfer and display files.

In addition to these advantages, the process used to reach this invention was very different from the one used to reach the CU-SeeMe software program. The current CU-SeeMe site uses a program called CU-SeeMe Pro which allows for videoconferencing over standard telephone lines. That program was modified so that it would be useful over the World Wide Web and then chat functionality was added to it.

This invention provides a system comprising a method which allows users to chat with each other while displaying live webcam images of more than one selected user within a chatroom environment. It also provides a method in which the webcam images are displayed at the top of the page. The invention also provides a method in which the displayed webcam images have a uniform size. It also provides a method in which the webcam images are automatically assigned a position on the chatroom screen. The invention also provides a method in which chatroom users can select the webcam images they want to view while they are chatting. It also provides a method in which each user is given a list of other online users from which they can select webcam images to view. It also provides a method in which a list of URLs from each user's personal webcam is requested and organized. The invention also provides a method in which each image is associated with an individual user. It also provides a method in which users who do not have a webcam will have a symbolic logo appear in place of their image. It also provides a method in which the symbolic logo is updated at a predefined time interval.

The invention provides a system which allows users to chat with each other while displaying live webcam images of more than one selected user within a chatroom environment. The invention also provides a system in which the webcam images are displayed at the top of the page. It also provides a system in which the displayed webcam images have a uniform size. It also provides a system in which the webcam images are automatically assigned a position on the chatroom screen. The invention provides a system in which chatroom users can select the webcam images they want to view while they are chatting. It also provides a system in which each user is given a list of other online users from which they can select webcam images to view. The invention provides a system in which a list of URLs from each user's personal webcam is requested and organized. It also provides a system in which each image is associated with an individual user. It also provides a system in which users who do not have a webcam will have a symbolic logo appear in place of their image.

The invention also provides a system in which the symbolic logo is updated at a predefined time interval. It further provides a method in which the setting is an Internet chatroom; in which Java Programming Language is used; in which there is no limit on the number of users that are allowed to participate in the chatroom; in which well-defined Internet standards are used to transfer and display files; in which video capabilities are added to a standard web-based chatroom; and in which the setting is an Internet chatroom.

This invention further provides a basic text-based chatroom software that is written with the Java Programming Language and is distributed over the Internet. The webcam chatroom allows a user to view a live webcam image of the person with whom he/she is chatting. One unique characteristic of this invention is that it displays webcam images of more than one user's picture at the top of the window, while displaying beneath the images the text that each user types in. When a chatter first visits the chatroom, the program asks the chatter if he/she would like to enter the URL of his/her webcam. If the chatter is interested, he/she enters the URL, and the program automatically associates the URL with that chatter's screen name. When one chatter double-clicks on another's screen name, the program invokes an algorithm that automatically removes one of the multiple webcam images from the top of the chat screen and replaces it with a live image from the chosen chatter's webcam. Different webcam manufacturers have different resolutions, and the invention addresses these differences by using the core functionality in the programming language to resize every image so that they all appear in the same size in the chatroom.

This program contains two distinct parts: The client and the Server. Each part functions separately, but they communicate with each other using the TCP/IP protocol. This functionality is provided in the Java Programming Language by Sun Microsystems.

The client program is responsible for receiving the images and text to be displayed from the server. In addition to displaying the data it receives from the server, the client also allows the user to participate in the discussion by typing in text, and also allows the user to select whom they wish to see on top of the screen by double clicking on their username on the right hand side. The client displays the list of available discussion rooms and allows the user to create a new one. The client is also responsible to retrieve list of users logged in to each discussion room and to retrieve messages from the current discussion room the user resides in.

The server program is responsible for getting the user information from the client. That information tells the server where it needs to download the webcam image from (the URL of the image), what the user has typed into the text box, and which chatters the user wishes to have displayed. The server then goes and downloads the images off the Internet (using FTP) and then sends the images to the client. The server also receives whatever text the client sends it and then resends it to all of the clients connected to the server. The server also keeps the clients updated with information pertaining to which users are connected and what discussion rooms are available.

Customer Service Solution

In another embodiment, the invention provides a method of providing customer service, comprising the steps of providing a means for instantly contacting one or more representatives by one or more customers, providing a means for real-time and simultaneous interaction between one or more representatives and one or more customers, and providing a means for displaying live webcam images of one or more representatives and one or more customers during said interaction.

To enable customers to quickly contact a customer service representative without undue effort, a URL link is provided that instantly connects one or more customers to one or more representatives without having to download additional software. The URL link may be located on the company's website or may be sent to a customer via e-mail.

Once connected, a customer can select and interact with a representative in a number of ways. The present invention provides for Voice over Internet Protocol (VOIP), which enables audio communication via regular phone calls between one or more representatives and one or more customers. The present invention also provides for an Instant Messaging System (IM), which enables instantaneous textual communication between one or more representatives and one or more customers. The IM feature allows a customer to send an global IM message to all the representatives listed or an individual IM message to a specific representative. Global IM messages are dropped from the message list as soon as one representative answers the customer's request. Furthermore, an e-mail system is provided, enabling e-mail communication between one or more representatives and one or more customers. The above-discussed means of interaction are advantageous in that they occur in real-time, meaning that the communication is received by the recipient essentially right after it is transmitted by the sender.

During the session, a customer will also be able to view live webcam images of one or more representatives. The live webcam image(s) serve as a virtual equivalent of a “smiling face behind the counter” and helps to personalize the interaction and adds to the feeling of attentiveness directed to the customer.

To facilitate the customer/representative interaction, an object is provided to the representative displaying relevant information, such as a customer's account information, contact information, orders, meetings & contacts, and the like.

During a session with a customer, a representative also has an opportunity for real-time interaction with one or more other representatives to more effectively serve the customer's needs. Representatives can communicate individual or group textual messages to each other and can enter chatrooms not accessible by customers. In a typical telephone scenario, a representative has to put the customer on hold while he/she calls another more knowledgeable representative. In such a situation, the customer may feel neglected/forgotten and/or become impatient since this scenario places the burden of the wasted wait time on the customer, who often has more info that he/she would like to disclose while waiting in silence.

On the other hand, with regard to the present invention, a representative can utilize the Instant Messaging System (IM) to send instantaneous textual messages to one or more other representatives without having to neglect the customer. For instance, while the customer is disclosing the nature of his/her problem, a representative may actively listen and send an instant text message to another representative without having to put the customer on hold. Thus, the representative is able to simultaneously interact with the customer and one or more other representatives in furtherance of a more effective session. The customer can continue elaborating with regard to the current issue or move on to the next matter while the representative waits for a response from his colleague(s), thus maximizing the use of a customer's time and minimizing lack of attention shown to each customer.

Another advantage is that even if wait time is involved, the representative is always in the view of the customer, providing a sense of one-on-one attention and further humanizing the customer service experience, which can feel rather impersonal and remote when, for instance, the interaction is limited to speaking into the receiver of a telephone and staring off into space. When the session with the representative is over, the customer can exit by just closing their web-browser program.

As described herein, a system is also disclosed for the method of providing the customer service solution discussed above, comprising a means for instantly contacting one or more representatives by one or more customers, a means for real-time and simultaneous interaction between one or more representatives and one or more customers, and a means for displaying live webcam images of one or more representatives and one or more customers. As additionally noted herein, the system comprises a program based on Java Programming Language, enabling its use across all platforms.

Developer Notes

1. How webcam images are displayed at the top of the chatroom page

The program periodically refreshes the webcam images by retrieving the chatter list from the Server, which contains chatters and their webcam URLs. The program then prepares the image by connecting to the Server via TCP. It reads the byte-array for each image. The image is initialized for the screen and placed at the top of the chatroom area.

2. How the webcams are automatically sized to have a uniform size

The program resizes the images from chatters' webcams by calculating scaled height and calculating scaled width. It then uses Java's built-in image-scaling method (getScaledInstance( )).

3. How the webcams are assigned a position on the screen

The program displays any number of webcam images on top of the screen. The displayed images consist of a one or more webcam images selected from all available webcam images. The program calculates screen “real-estate” (size of the window) based on the number of webcam images displayed and the size of each webcam image.

4. How the system of selecting users works.

To select the webcam of a specific chatter, another chatter double-clicks on a username from the list of available users. That person's image is placed on top of the screen, and a non-selected person's image is removed.

### REFERENCES

1) Lynch, Keith, “Keith Lynch's timeline of net related terms and concepts,” http://keithlynch.net/timeline.html , May 18, 2000.
2) McDaniel, Robert, “The Beginner's Guide to Internet Chat,” CNET, http://www.cnet.com/internet/0-3781-7-1519050.html?tag=st.sr.3781-7-1519051.subnav.3781-7-1519050, Oct. 28, 1998
3) iFriends Network, “About iFriends,” http://www.ifriends.net/who.htm May 2000.
4) CU-SeeMe Networks, “CuseeMe Networks: CU-SeeMe Pro,” http://www.cuseeme.com/software/pro_bus.htm, April 2000.
5) Postel, J. & Reynolds, J, “File Transfer Protocol (RFC 959),” http://www.w3.org/Protocols/rfc959/ October 1985.
6) Postel, J., “NCP/TCP Transition Plan (RFC 801),” http://www.cis.ohio-state.edu/htbin/rfc/rfc801.html, November 1981.

1. A method of customer service, comprising:
providing a means for instantly contacting one or more representatives by one or more customers,
providing a means for real-time and simultaneous interaction between one or more representatives and one or more customers, and
providing a means for displaying live webcam images of one or more representatives and one or more customers during said interaction.

2. The method of claim 1, wherein the means for contacting comprises providing a URL link that instantly connects one or more customers to one or more representatives without having to download additional software.

3. The method of claim 1, wherein the means for interaction comprises providing Voice over Internet Protocol (VOIP), enabling audio communication between one or more representatives and one or more customers.

4. The method of claim 1, wherein the means for interaction comprises providing Instant Messaging System (IM), enabling instantaneous textual communication between one or more representatives and one or more customers.

5. The method of claim 1, wherein the means for interaction comprises providing an e-mail system, enabling e-mail communication between one or more representatives and one or more customers.

6. The method of claim 1, further comprising providing a means for real-time interaction amongst two or more representatives during interaction with one or more customers.

7. The method of claim 6, wherein the means for interaction amongst representatives comprises providing Instant Messaging System (IM), enabling instantaneous textual communication between two or more representatives.

8. A system for providing customer service, comprising:
a means for instantly contacting one or more representatives by one or more customers,
a means for real-time and simultaneous interaction between one or more representatives and one or more customers, and
a means for displaying live webcam images of one or more representatives and one or more customers during said interaction.

9. The system of claim 8, wherein the means for contacting comprises a URL link that instantly connects one or more customers to one or more representatives without having to download additional software.

10. The system of claim 8, wherein the means for interaction comprises Voice over Internet Protocol (VOIP), enabling audio communication between one or more representatives and one or more customers.

11. The system of claim 8, wherein the means for interaction comprises Instant Messaging System (IM), enabling instantaneous textual communication between one or more representatives and one or more customers.

12. The system of claim 8, wherein the means for interaction comprises an e-mail system, enabling e-mail communication between one or more representatives and one or more customers.

13. The system of claim 8, further comprising a means for real-time interaction amongst two or more representatives during interaction with one or more customers.

14. The system of claim 13, wherein the means for interaction amongst representatives comprises Instant Messaging System (IM), enabling instantaneous textual communication between two or more representatives.

15. The system of claim 8, wherein the customer is represented by an object which displays said customer's account information, comprising customer's contact information, orders, and meetings and contacts.

16. The system of claim 8, further comprising a program based on Java Programming Language, enabling use across all platforms.
